(19) United States
(12) Patent Application Publication
(10) Pub. No.: US 2018/0181440 A1
(43) Pub. Date: Jun. 28, 2018

(54) RESOURCE ALLOCATION SYSTEM, APPARATUS ALLOCATION CONTROLLER AND APPARATUS RECOGNIZING METHOD

(71) Applicant: H3 Platform, Inc., New Taipei City (TW)

(72) Inventor: Yu-Ching Chou, New Taipei City (TW)

(73) Assignee: H3 Platform, Inc., New Taipei City (TW)

(21) Appl. No.: 15/853,947

(22) Filed: Dec. 25, 2017

(30) Foreign Application Priority Data
Dec. 26, 2016 (TW) 105143235

(51) Int. Cl. G06F 9/50; G06F 13/40; G06F 9/455

(52) U.S. Cl. CPC G06F 9/5022; G06F 9/5077; H04L 61/6022; G06F 9/45558; G06F 2213/0026; G06F 13/4022

(57) ABSTRACT

An apparatus allocation controller includes a control circuit, a bus, and a read-only memory. The control circuit includes multiple switch chipsets. The switch chipsets are electrically connected to multiple servers through multiple connection ports. The bus is electrically connected to multiple peripheral apparatuses. The control circuit sets a unique identifier belonging to the apparatus allocation controller and writes the unique identifier to a read-only memory of each of the switch chipsets. The control circuit determines a resource allocation table according to the unique identifier of the apparatus allocation controller, a plurality of switch chipset serial numbers corresponding to the switch chipsets and a plurality of station numbers. The resource allocation table is configured to recognize resource usage statuses of the servers using the peripheral apparatuses through the apparatus allocation controller. In addition, a resource allocation system and an apparatus recognizing method are also provided.

### CROSS-REFERENCE TO RELATED APPLICATION

This application claims the priority benefit of Taiwan application serial no. 105143235, filed on Dec. 26, 2016. The entirety of the above-mentioned patent application is hereby incorporated by reference herein and made a part of this specification.

### BACKGROUND OF THE INVENTION

### 1. Field of the Invention

The invention relates an allocation technique for network physical resources, and more particularly, to a resource allocation system, an apparatus allocation controller, and an apparatus recognizing method.

### 2. Description of Related Art

With advancements in cloud networking technology, many cloud computing centers emerge and lead to increasingly more demands on computing and data access. Conventionally, a resource allocation adopts use of one single apparatus allocation controller for electrically connecting servers to peripheral apparatuses. However, when apparatus resources electrically connected to the apparatus allocation controller gradually increase, the connection relations between the apparatus resources and the servers need to be dynamically adjusted according to usage status of the servers. These connection relations will become even more complex due to the increasing numbers of the apparatus resources and the servers. In other words, when the quantity of the apparatus resources is huge, the resources allocated to the servers may not be effectively managed by one single apparatus allocation controller. If we want to manage the servers and the apparatus resources collaboratively by using multiple apparatus allocation controllers, to find a way for the apparatus allocation controllers to recognize and communicate with one another will be a major issue to be addressed.

### SUMMARY

The invention is directed to a resource allocation system, an apparatus allocation controller and an apparatus recognizing method, which are capable of recognizing usage statuses of multiple servers using multiple peripheral apparatuses electrically connected to each apparatus allocation controller according to the unique identifier included by each apparatus allocation controller. In this way, the management console according to the embodiments of the invention can effectively manage the apparatus resource allocation of the apparatus allocation controllers.

The resource allocation system of the invention includes a plurality of apparatus allocation controllers, a plurality of servers, a plurality of peripheral apparatuses and a management console. The apparatus allocation controllers each have a plurality of switch chipsets. The servers are electrically connected to the apparatus allocation controllers through a plurality of connection ports of each of the apparatus allocation controllers. The peripheral apparatuses are electrically connected to the apparatus allocation controllers through a bus of each of the apparatus allocation controllers. The management console is configured to output an apparatus resource request to the apparatus allocation controllers to obtain a plurality of resource allocation tables corresponding to the apparatus allocation controllers, so that the management console allocates the peripheral apparatuses to the servers according to the resource allocation tables. The apparatus allocation controllers each have a different unique identifier. The apparatus allocation controllers each determine the resource allocation tables according to the unique identifier, a plurality of chipset serial numbers corresponding to the switch chipsets and a plurality of station numbers. The resource allocation table is configured to recognize resource usage statuses of the servers using the peripheral apparatuses through the apparatus allocation controller.

In an embodiment of the invention, the management console is disposed in one of the servers.

In an embodiment of the invention, the apparatus allocation controllers each map connection relations of the servers electrically connected to the switch chipsets through the connection ports to the switch chipset serial numbers by a port mapping.

In an embodiment of the invention, the apparatus allocation controllers each establish the station numbers by a port mapping according to usage statuses of the servers using the peripheral apparatuses through the switch chipsets.

In an embodiment of the invention, the unique identifier of each of the apparatus allocation controllers is determined at least according to a media access control address, a communication protocol address or a central processing unit serial number.

In an embodiment of the invention, each of the switch chipsets includes a read-only memory configured to store the unique identifier.

The invention provides an apparatus allocation controller, which includes a control circuit and a bus. The control circuit has a plurality of switch chipsets. The switch chipsets are electrically connected to a plurality of servers through a plurality of connection ports. The bus is electrically connected to a plurality of peripheral apparatuses, and the peripheral apparatuses match a peripheral component interconnect express standard. The control circuit sets a unique identifier belonging to the apparatus allocation controller and writes the unique identifier to a read-only memory of each of the switch chipsets. The control circuit determines a resource allocation table according to the unique identifier of the apparatus allocation controller, a plurality of switch chipset serial numbers corresponding to the switch chipsets and a plurality of station numbers. The resource allocation table is configured to recognize resource usage statuses of the servers using the peripheral apparatuses through the apparatus allocation controller.

In an embodiment of the invention, the apparatus allocation controllers each map connection relations of the servers electrically connected to the switch chipsets through the connection ports to the switch chipset serial numbers by a port mapping.

In an embodiment of the invention, the apparatus allocation controllers each establish the station numbers by a port mapping according to usage statuses of the servers using the peripheral apparatuses through the switch chipsets.

In an embodiment of the invention, according to an apparatus resource request of a management console of one of the servers, the control circuit provides the resource allocation table to the management console, so the management console allocates the peripheral apparatuses to the servers according to the resource allocation table.

In an embodiment of the invention, the unique identifier is determined at least according to a media access control address, a communication protocol address or a central processing unit serial number.

In an embodiment of the invention, the read-only memory is an electrically erasable programmable read-only memory.

The invention provides an apparatus recognizing method adapted to an apparatus allocation controller. The apparatus allocation controller comprises a control circuit having a plurality of switch chipsets and a bus electrically connected to a plurality of peripheral apparatuses. The apparatus allocation controller is electrically connected to a plurality of servers through a plurality of connection ports. The apparatus recognizing method includes following steps: setting a unique identifier belonging to the apparatus allocation controller and writing the unique identifier to a read-only memory of each of the switch chipsets; and setting a resource allocation table according to the unique identifier of the apparatus allocation controller, a plurality of chipset serial numbers corresponding to the switch chipsets and a plurality of station numbers.

In an embodiment of the invention, the step of setting the resource allocation table includes following steps: executing a port mapping to map connection relation of the servers electrically connected to the switch chipsets through the connection ports to the switch chipset serial numbers.

In an embodiment of the invention, the step of setting the resource allocation table includes following steps: executing a port mapping to establish the station numbers according to usage statuses of the servers using the peripheral apparatuses through the switch chipsets.

In an embodiment of the invention, the apparatus recognizing method further includes following steps: according to an apparatus resource request of a management console of one of the servers, providing the resource allocation table to the management console, so the management console allocates the peripheral apparatuses to the servers according to the resource allocation table.

In an embodiment of the invention, the unique identifier is determined at least according to a media access control address, a communication protocol address or a central processing unit serial number.

In an embodiment of the invention, the read-only memory is an electrically erasable programmable read-only memory.

Based on the above, the resource allocation system, the apparatus allocation controller and the apparatus recognizing method according to the embodiments of the invention can create the resource allocation table for each of the apparatus allocation controllers by setting the unique identifier for each of the apparatus allocation controller. Thus, the apparatus allocation controller according to the embodiments of the invention can create the resource allocation table according to the unique identifier, the chipset serial numbers of the switch chipsets and the station numbers. In other words, the management console recognizes the usage statuses of the servers using the peripheral apparatuses electrically connected to each apparatus allocation controller according to the resource allocation tables having the different unique identifiers. Therefore, the resource allocation system, the apparatus allocation controller and the apparatus recognizing method proposed according to the embodiments of the invention can effectively manage the apparatus resource allocation for the multiple apparatus allocation controllers.

To make the above features and advantages of the disclosure more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates a schematic diagram of a resource allocation system according to an embodiment of the invention.

FIG. 2 illustrates a schematic diagram of an apparatus allocation controller according to an embodiment of the invention.

FIG. 3 illustrates a schematic diagram of a switch chipset according to an embodiment of the invention.

FIG. 4 illustrates a schematic diagram of operation for recognizing apparatus according to an embodiment of the invention.

FIG. 5 illustrates a flowchart of an apparatus recognizing method according to an embodiment of the invention.

FIG. 6 illustrates a flowchart of an apparatus recognizing method according to other embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

For connection relations between peripheral apparatuses and servers, the embodiments of the invention propose a resource allocation system, an apparatus allocation controller and an apparatus recognizing method, which are capable of simultaneously controlling multiple apparatus allocation controllers through a management console. The apparatus allocation controller can be used to set a unique identifier that is different from those of the other apparatus allocation controllers. When each of the apparatus allocation controllers is creating a resource allocation table of its own, the management console can recognize usage status for the peripheral apparatuses from the different apparatus allocation controllers by the unique identifier, thus the management console can control multiple apparatus allocation controllers effectively.

The term “electrically connected” used in this specification (including claims) of the present application may refer to any direct or indirect connection means. For example, “a first device is electrically connected to a second device” should be interpreted as “the first device is directly connected to the second device” or “the first device is indirectly connected to the second device through other devices or connection means”. Moreover, wherever appropriate in the drawings and embodiments, elements/components/steps with the same reference numerals represent the same or similar parts. Elements/components/steps with the same reference numerals or names in different embodiments may be cross-referenced.

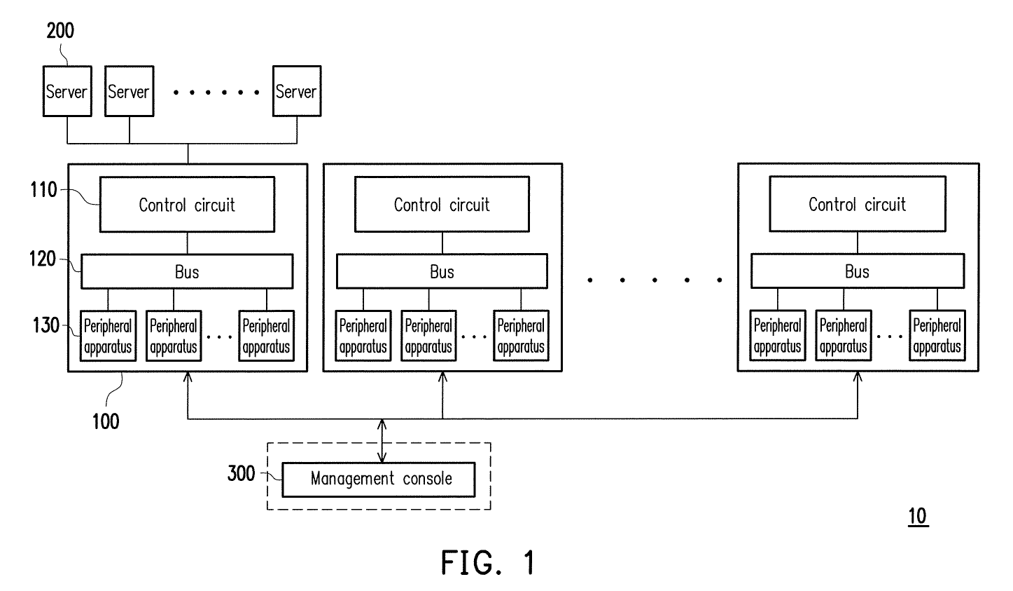

FIG. 1 illustrates a schematic diagram of a resource allocation system according to an embodiment of the invention. Referring to FIG. 1, a resource allocation system 10 includes a plurality of apparatus allocation controllers 100 and a plurality of servers 200. Each of the apparatus allocation controllers 100 includes a control circuit 110 and a bus 120. The bus 120 is used to electrically connect a plurality of peripheral apparatuses 130. In the present embodiment, each apparatus allocation controller may be electrically connected to the servers 200 through multiple buses. In other words, the servers 200 are electrically connected to the apparatus allocation controller 100 to conduct a data transmission with the peripheral apparatuses 130. In the present embodiment, the control circuit 110 is used to electrically connect the servers 200 with the peripheral apparatuses 130 for conducting a data exchange and an apparatus allocation. In the present embodiment, the control circuit 110 can include a plurality of switch chipsets, configured to execute operation of the data exchange and the apparatus allocation between the servers 200 and the peripheral apparatuses 130. Incidentally, in the present embodiment, the bus 120 and the peripheral apparatuses 130 match a peripheral component interconnect express (PCIe) standard.

In the present embodiment, the apparatus allocation controller 100 is an exchange control device capable of dynamically allocating the peripheral apparatuses 130 to the servers 200 or a plurality of virtual machines (VMs) in at least one operation system (OS). In other words, the apparatus allocation controller 100 can control whether to conduct a data communication between the peripheral apparatuses 130 and the servers 200.

In the present embodiment, the control circuit 110 can be used to execute an apparatus allocation method and an apparatus recognizing method according to each embodiment of the invention. The control circuit 110 may be, for example, a central processing unit (CPU), a micro processor unit (MPU) or a micro control unit (MCU), but the invention is not limited to the above. Further, in the present embodiment, the control circuit 110 can realize the apparatus allocation method and apparatus recognizing method described in the invention in form of programs (software) or logic circuits (hardware).

In the present embodiment, the peripheral apparatuses 130 may include a graphics processing unit (GPU), a general-purpose computing on graphics processing unit (GPGPU), a non-volatile memory express (NVMe) memory, a solid state disk (SSD), a Network interface controller (NIC), a field-programmable gate array (FPGA), a Redundant array of independent disk (RAID) or any other similar devices or a combination of the above, which are not particularly limited by the invention. In the present embodiment, the peripheral apparatus 130 described above is compatible with a single root I/O virtualization (SR-IOV) standard, so the apparatus allocation controller 100 can virtualize the peripheral apparatuses 130 into multiple virtual apparatuses compatible with a SR-IOV technology and further include one or more PCIe physical functions (PFs) where each physical function can correspond to at least one virtual function (VF). The virtual function can be used and classified as the virtual machine. Alternatively, in an embodiment, the peripheral apparatus 130 can also include multiple physical apparatuses directly providing the physical functions.

In the present embodiment, the server 200 may be a device provided with the CPU (Central Processing Unit), including a rack-type or tower-type server, a desktop computer, a notebook computer, etc. In the present embodiment, when the servers 200 are connected to the peripheral apparatuses 130 through the apparatus allocation controller 100, the apparatus allocation controller 100 can allocate the peripheral apparatuses 130 according to apparatus requirements from each server 200, so the respective server 200 can extend software or hardware resources required by the server 200 with use of the peripheral apparatuses 130.

Specifically, in the present embodiment, when a management console 300 intends to manage the apparatus allocation controllers 100, the management console 300 will send an apparatus resource request to each of the apparatus allocation controllers 100 and makes each of the apparatus allocation controllers 100 reply a resource allocation table back to the management console 300 according to the apparatus resource request. When the resource allocation tables are received by the management console 300 from each of the apparatus allocation controllers 100, the management console 300 can allocate the peripheral apparatuses 130 to the servers 200 according to the resource allocation tables and the apparatus resources required by the server 200. In this regard, in the present embodiment, each of the apparatus allocation controllers 100 is assigned with a different unique ID, so the management console 300 can recognize the resource allocation tables from the different apparatus allocation controllers 100. Also, the apparatus allocation controller 100 can generate the resource allocation table by combining the unique identifier, a plurality of switch chipset serial numbers corresponding to the switch chipsets and a plurality of station numbers. In this way, the resource allocation tables provided from each of the apparatus allocation controllers 100 can have a different serial number arrangement, so the management console 300 can recognize resource usage statuses of the servers 200 using the peripheral apparatuses 130 through the apparatus allocation controllers 100. It should be noted that, in the present embodiment, the unique identifier can be determined according to at least one of a media access control address (MAC address), a communication protocol address (IP address) and a central processing unit serial number. In other words, each of the apparatus allocation controllers 100 can be set to include a different unique identifier. In other embodiment of the invention, due to each of the apparatus allocation controllers has a unique MAC address, the unique identifier of the apparatus allocation controller 400 may be only determined or set according to the unique MAC address belonging to the apparatus allocation controller 400. The unique identifier of the apparatus allocation controller 400 may be set the same as the MAC address belonging to the apparatus allocation controller 400.

Further, in the present embodiment, the management console 300 can be realized among the servers 200 in software or hardware manner. In other words, one of the servers 200 can be used as a host to allocate the peripheral apparatuses 130 of the apparatus allocation controllers 100 according to the resource requirements from each server, but the invention is not limited to the above. In an embodiment, the management console 300 may also be disposed on an extra external control device. The external control device can include a processor for executing the management console 300 stored in a storage device, and the external control device is electrically connected to the apparatus allocation controllers 100.

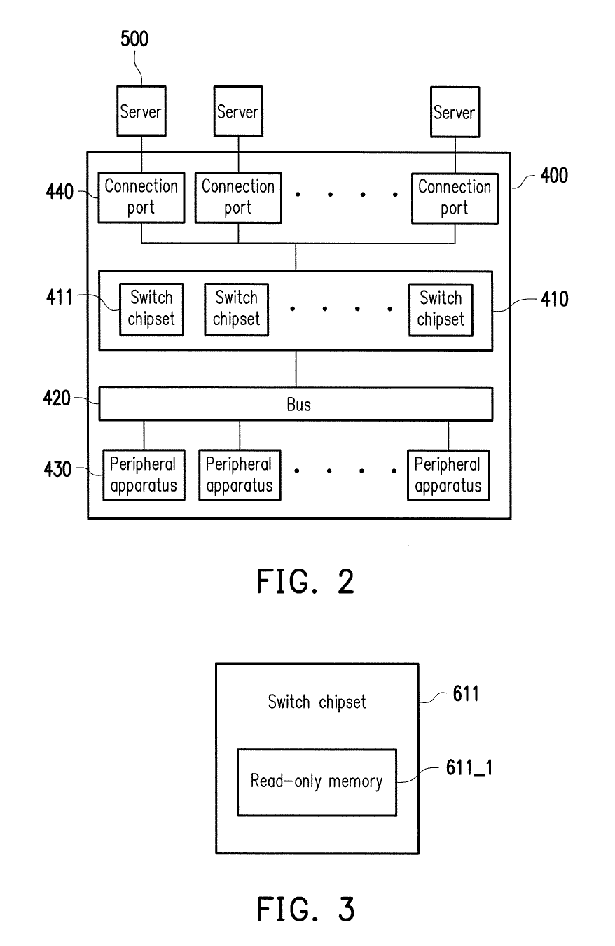

FIG. 2 illustrates a schematic diagram of an apparatus allocation controller according to an embodiment of the invention. Referring to FIG. 2, an apparatus allocation controller 400 includes a control circuit 410, a bus 420, and a plurality of peripheral apparatuses 430. The apparatus allocation controller 400 is electrically connected to the plurality of peripheral apparatuses 430 through the bus 420. The apparatus allocation controller 400 is electrically connected to a plurality of servers 500 through a plurality of connection ports 440. In the present embodiment, the control circuit 410 can include a plurality of switch chipsets 411, and each of the switch chipsets 411 includes a different chipset serial number. The switch chipsets 411 are configured to execute operation of the data exchange and the apparatus allocation between the servers 500 and the peripheral apparatuses 430.

With reference to FIG. 3, FIG. 3 illustrates a schematic diagram of a switch chipset according to an embodiment of the invention. A switch chipset 611 shown in FIG. 3 can represent the switch chipset described in each of the foregoing embodiments. In detail, the switch chipset 611 is built in with a read-only memory 611_1, and the read-only memory 611_1 may be an electrically erasable programmable read only memory (EEPROM). In the present embodiment, the read-only memory 611_1 can be used to store the unique identifier written by the control circuit. However, the invention is not limited thereto. In an embodiment, it can also be used for writing information into the read-only memory 611_1 such as the chipset serial numbers, the station numbers or the resource allocation tables. In other embodiment of the invention, a consistent search number can be set in the read-only memory of each switch chipset (i.e., all switch chipsets 611) in the apparatus allocation controller 400, so that the management console 300 in FIG. 1 may be easy to identify the switching chipsets located in the different device allocation controllers.

Referring to FIG. 2, in the present embodiment, after the server 500 is electrically connected to the connection port 440, the connection port 440 is further electrically connected to one of the switch chipsets 411. Accordingly, the control circuit 410 maps a sequence or a numbering of the server 500 electrically connected to the connection port 440 to the switch chipset serial number of the substantially electrically connected switch chipset 411 by a port mapping. Moreover, the control circuit 410 further maps a sequence or a numbering of the switch chipset 411 electrically connected to the peripheral apparatus 430 through the bus 420, also by the port mapping, to the chipset serial number of the substantially electrically connected switch chipset 411, to create the station numbers. In other words, the station number can be used to represent the connecting sequence or the numbering of the peripheral apparatuses 430 electrically connected to the switch chipset 411, or to represent a connection relation between the server 500 and the peripheral apparatus 430 in actual electrical connection for transmitting data. In other embodiment of the invention, the station number for each server 500 can be determined according to the port number belonging to the connection ports 440 of the apparatus allocation controller 400 which is connected to the server 500.

It is noted that, the so-called “port mapping” as described in the foregoing embodiments can refer to operation of the control circuit 410 for recording a physical address (e.g., a network address, a unique PCIe serial number in a register of the server, or a port number for connecting the server 500 to the apparatus allocation controller 400), an address of PCIe apparatus allocation controller (e.g., a unique PCIe serial number in a register of the PCIe apparatus allocation controller, or a chipset port number) included by the apparatus allocation controller 400 to which the server 500 belongs and resources included by the server or the apparatus allocation controller 400 (e.g., resources to be sent to the PCIe apparatus allocation controller for unified and centralized management), and organizing the above data (the address of the PCIe apparatus allocation controller, the physical address or the resources) into a routing table. As such, the control circuit 410 can then determine where a source address and a target address in a received packet must be moved forward to according to the routing table. The “port mapping” is similar to the routing technique in TCP/IP (Transmission Control Protocol/Internet protocol).

In addition, in the present embodiment, the connection port 440 matches the PCIe (Peripheral Component Interconnect Express) standard. The server 500 can be electrically connected to the connection port 440 through a cable in order to transmit data to the peripheral apparatus 430 through the apparatus allocation controller 400. However, in the embodiments of the invention, the method for coupling the apparatus allocation controller 400 with the server 500 may be decided depending on a transmission interface adopted by person who applies the present embodiment, which is not particularly limited by the invention so long as the intercommunication can be made through the PCIe.

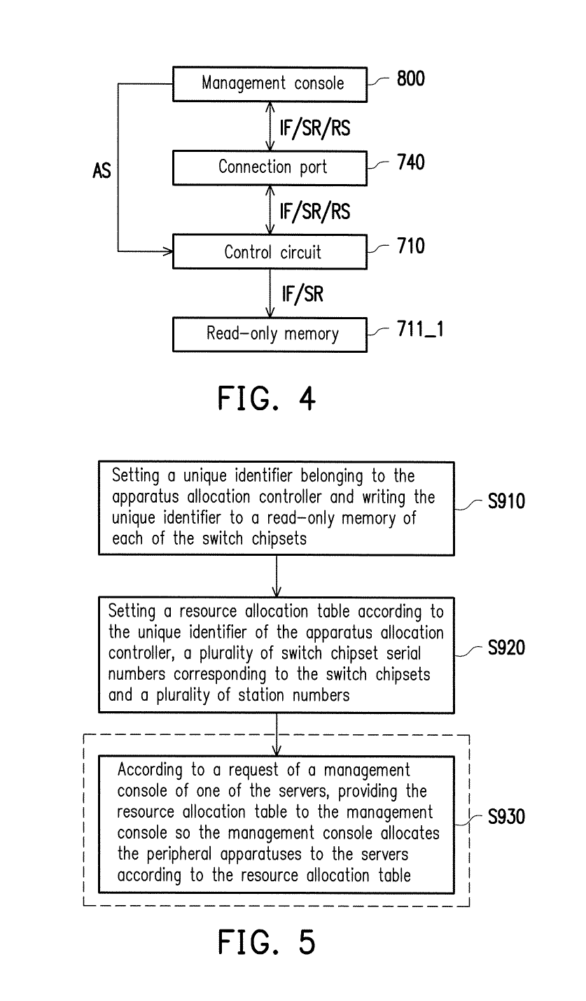

FIG. 4 illustrates a schematic diagram of operation for recognizing apparatus according to an embodiment of the invention. Referring to FIG. 4, more specifically, a management console 800, a connection port 740, a control circuit 710 and a read-only memory 711_1 of FIG. 4 may be the management console, the connection port, the control circuit and the read-only memory adapted to each of the foregoing embodiments. In the present embodiment, when the management console 800 sends an apparatus resource request RS to the control circuit 710 of an apparatus switch controller through the console connection port 740, the control circuit 710 can reply information including a resource allocation table having a unique identifier IF and/or search number SR back to the management console 800 through the console connection port 740 and write the resource allocation table having the unique identifier IF and/or search number SR to the read-only memory 711_1 of the switch chipset. Accordingly, the management console 800 can output an allocation signal AS to the control circuit 710 via the Internet, so the control circuit 710 can proceed to tasks for allocation of the peripheral apparatuses. In other embodiment of the invention, the resource allocation table may include, in addition to the unique identification code IF corresponding to the MAC address, the search number SR for each switch chipset.

FIG. 5 illustrates a flowchart of an apparatus recognizing method according to an embodiment of the invention. Referring to FIG. 2 and FIG. 5 together, the method of the present embodiment is at least adapted to the apparatus allocation controller 400 and the server 500 in FIG. 2. In step S910, the control circuit 410 sets a unique identifier belonging to the apparatus allocation controller 400 and writes the unique identifier to a read-only memory of each of the switch chipsets 411. In step S920, the control circuit 410 sets a resource allocation table according to the unique identifier of the apparatus allocation controller 400, a plurality of switch chipset serial numbers corresponding to the switch chipsets 411 and a plurality of station numbers. In other words, regardless of whether there is a console sending the apparatus resource request or not, the apparatus allocation controller 400 can, according to the usage statuses of the peripheral apparatuses 430 therein, set the resource allocation table in advance. Next, in step S930, according to a request of a management console of one of the servers 500, the control circuit 410 provides the resource allocation table to the management console, so the management console can allocate the peripheral apparatuses 430 to the servers 500 according to the resource allocation table. In other words, if one of the servers 500 is the host having the management console, the server 500 having the management console can obtain the resource allocation table through the connection port and allocate the peripheral apparatuses 430 to the servers 500 according to the resource allocation table.

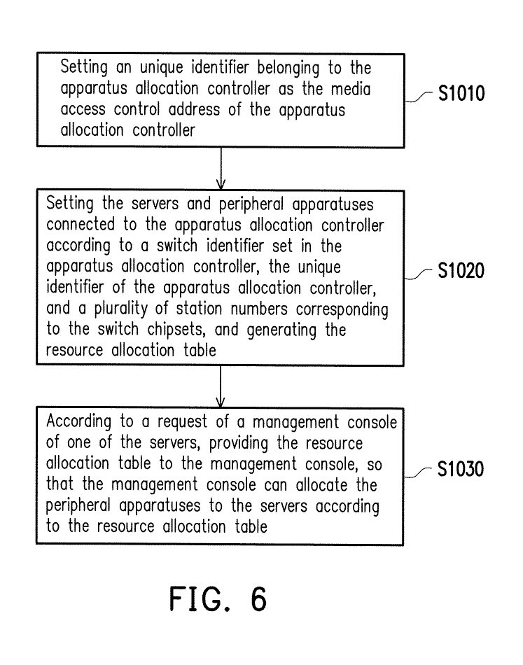

FIG. 6 illustrates a flowchart of an apparatus recognizing method according to other embodiment of the invention. Referring to FIG. 2 and FIG. 5 together, the method of the present embodiment is at least adapted to the apparatus allocation controller 400 and the server 500 in FIG. 2. In step S1010, the control circuit 410 sets an unique identifier belonging to the apparatus allocation controller 400 as the media access control address of the apparatus allocation controller 400. In the embodiment of the invention, the unique identifier may be memorized in the dynamic random access memory of the control circuit 410 of the apparatus allocation controller 400 while the apparatus allocation controller 400 is booting. In step S1020, the control circuit 410 sets the servers 500 and peripheral apparatuses 430 connected to the apparatus allocation controller 400 according to a switch identifier set in the apparatus allocation controller 400, the unique identifier of the apparatus allocation controller 400 (i.e., the media access control address of the apparatus allocation controller 400), and a plurality of station numbers corresponding to the switch chipsets 411 (i.e., the port number belonging to the connection ports of the apparatus allocation controller 400 which is connected to one of the servers 500), and generates the resource allocation table. The resource allocation table is configured to present all the servers 500 and all peripheral devices 430 connected to the device allocation controller 400. The switch identifier set in the apparatus allocation controller 400 may be defined by default setting. Next, in step S1030, according to a request of a management console of one of the servers 500, the control circuit 410 provides the resource allocation table to the management console, so the management console can allocate the peripheral apparatuses 430 to the servers 500 according to the resource allocation table.

In summary, the control circuit of the apparatus allocation controller according to the embodiments of the invention is capable of setting the unique identifier. Further, the apparatus allocation controller can map the connection relations of the servers electrically connected to the switch chipsets through the connection ports to the switch chipset serial numbers and establish multiple station numbers according to usage statuses of the servers using the peripheral apparatuses through the switch chipsets. Thus, the apparatus allocation controller according to the embodiments of the invention can create the resource allocation table according to the unique identifier, the chipset serial numbers of the switch chipsets and the station numbers. In other words, when the management console sends the apparatus resource request to the apparatus allocation controllers, each of the apparatus allocation controllers can provide the resource allocation table of its own, and the management console can recognize the resource usage status of each server using the peripheral apparatuses through different apparatus allocation controllers according to the resource allocation tables having different unique identifier. As a result, the resource allocation system, the apparatus allocation controller and the apparatus recognizing method proposed according to the embodiments of the invention can effectively manage tasks of multiple apparatus allocation controllers for allocating the apparatus resources.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A resource allocation system, comprising:
a plurality of apparatus allocation controllers each having a plurality of switch chipsets;
a plurality of servers, electrically connected to the apparatus allocation controllers through a plurality of connection ports of each of the apparatus allocation controllers;
a plurality of peripheral apparatuses, electrically connected to the apparatus allocation controllers through a bus of each of the apparatus allocation controllers; and
a management console, configured to output an apparatus resource request to the apparatus allocation controllers to obtain a plurality of resource allocation tables corresponding to the apparatus allocation controllers, so that the management console allocates the peripheral apparatuses to the servers according to the resource allocation tables,
wherein the apparatus allocation controllers each have a different unique identifier, and the apparatus allocation controllers each determine the resource allocation tables according to the unique identifier, a plurality of chipset serial numbers corresponding to the switch chipsets and a plurality of station numbers, wherein the resource allocation tables are configured to recognize resource usage statuses of the servers using the peripheral apparatuses through the apparatus allocation controllers.

2. The resource allocation system according to claim 1, wherein the management console is disposed in one of the servers.

3. The resource allocation system according to claim 1, wherein the apparatus allocation controllers each map connection relations of the servers electrically connected to the switch chipsets through the connection ports to the switch chipset serial numbers by a port mapping.

4. The resource allocation system according to claim 1, wherein the apparatus allocation controllers each establish the station numbers by a port mapping according to usage statuses of the servers using the peripheral apparatuses through the switch chipsets.

5. The resource allocation system according to claim 1, wherein the unique identifier of each of the apparatus allocation controllers is determined at least according to a media access control address, a communication protocol address or a central processing unit serial number.

6. The resource allocation system according to claim 1, wherein each of the switch chipsets includes a read-only memory configured to store the unique identifier.

7. An apparatus allocation controller, comprising:
a control circuit having a plurality of switch chipsets, wherein the switch chipsets are electrically connected to a plurality of servers through a plurality of connection ports; and
a bus, electrically connected to a plurality of peripheral apparatuses, the peripheral apparatuses matching a peripheral component interconnect express standard,
wherein the control circuit sets a unique identifier belonging to the apparatus allocation controller and writes the unique identifier to a read-only memory of each of the switch chipsets, and the control circuit determines a resource allocation table according to the unique identifier of the apparatus allocation controller, a plurality of switch chipset serial numbers corresponding to the switch chipsets and a plurality of station numbers, wherein the resource allocation table is configured to recognize resource usage statuses of the servers using the peripheral apparatuses through the apparatus allocation controller.

8. The apparatus allocation controller according to claim 7, wherein the apparatus allocation controller maps connection relations of the servers electrically connected to the switch chipsets through the connection ports to the switch chipset serial numbers by a port mapping.

9. The apparatus allocation controller according to claim 7, wherein the apparatus allocation controller establishes the station numbers by a port mapping according to usage statuses of the servers using the peripheral apparatuses through the switch chipsets.

10. The apparatus allocation controller according to claim 7, wherein according to an apparatus resource request of a management console of one of the servers, the control circuit provides the resource allocation table to the management console, so the management console allocates the peripheral apparatuses to the servers according to the resource allocation table.

11. The apparatus allocation controller according to claim 7, wherein the unique identifier is determined at least according to a media access control address, a communication protocol address or a central processing unit serial number.

12. The apparatus allocation controller according to claim 7, wherein the read-only memory is an electrically erasable programmable read-only memory.

13. An apparatus recognizing method adapted to an apparatus allocation controller, wherein the apparatus allocation controller comprises a control circuit having a plurality of switch chipsets and a bus electrically connected to a plurality of peripheral apparatuses, and the apparatus allocation controller is electrically connected to a plurality of servers through a plurality of connection ports, wherein the apparatus recognizing method comprises:
setting a unique identifier belonging to the apparatus allocation controller and writing the unique identifier to a read-only memory of each of the switch chipsets; and
setting a resource allocation table according to the unique identifier of the apparatus allocation controller, a plurality of chipset serial numbers corresponding to the switch chipsets and a plurality of station numbers.

14. The apparatus recognizing method according to claim 13, wherein the step of setting the resource allocation table comprises:
executing a port mapping to map connection relations of the servers electrically connected to the switch chipsets through the connection ports to the switch chipset serial numbers.

15. The apparatus recognizing method according to claim 13, wherein the step of setting the resource allocation table comprises:
executing a port mapping to establish the station numbers according to usage statuses of the servers using the peripheral apparatuses through the switch chipsets.

16. The apparatus recognizing method according to claim 13, further comprising:
according to an apparatus resource request of a management console of one of the servers, providing the resource allocation table to the management console, so the management console allocates the peripheral apparatuses to the servers according to the resource allocation table.

17. The apparatus recognizing method according to claim 13, wherein the unique identifier is determined at least according to a media access control address, a communication protocol address or a central processing unit serial number.

18. The apparatus recognizing method according to claim 13, wherein the read-only memory is an electrically erasable programmable read-only memory.
